(19) United States
(12) Patent Application Publication
(10) Pub. No.: US 2009/0130332 A1
(43) Pub. Date: May 21, 2009

(54) COATING FILM DRYING METHOD AND COATING FILM DRYING APPARATUS

(75) Inventors: Satoshi HORISAWA, Tokyo (JP); Sigetaka TOOKA, Tokyo (JP); Kouzou ISHIDA, Tokyo (JP); Takaomi MATSUDA, Hiroshima (JP); Toshiyuki SAKODA, Hiroshima (JP); Teruo KANDA, Hiroshima (JP); Kazuhi KOGA, Hiroshima (JP)

Correspondence Address: Studebaker & Brackett PC, 1890 Preston White Drive, Suite 105, Reston, VA, 20191, US

(73) Assignees: TAIKISHA LTD., Tokyo (JP); MAZDA MOTOR CORPORATION, Hiroshima (JP)

(21) Appl. No.: 12/266,840

(22) Filed: Nov. 7, 2008

(30) Foreign Application Priority Data
Nov. 15, 2007 (JP) 2007-296597

(51) Int. Cl. B05D 3/06

(52) U.S. Cl. 427/542; 118/643

(57) ABSTRACT

Disclosed is a method and apparatus for drying a coating film (4a) on an exterior panel of a box-shaped workpiece (4), wherein radiant rays, and warm air having a temperature less than a hardening temperature of the coating film (4a), are supplied simultaneously and directly to the coating film (4a). The method and apparatus of the present invention can dry the coating film (4a) on the exterior panel of the workpiece (4) within a relatively short period of time, without causing a negative effect on a surface quality of the coating film (4a).

### BACKGROUND OF THE INVENTION

1. Field of the Invention

The present invention relates to a method and apparatus for drying a coating film on an exterior panel of a box-shaped workpiece.

2. Description of the Background Art

As a coating film drying technique, there has been proposes one type designed to blow hot air against a coating film on an exterior panel of a box-shaped workpiece, as disclosed, for example, in JP 2003-236437A. This technique can accelerate water evaporation from a surface of the coating film to facilitate drying the coating film.

Recently, there exists a need for a drying technique capable of reducing a time required for drying a coating film, from the standpoint of introducing a water-based paint in connection with reduction of volatile organic solvents, etc. As such a drying technique, it is contemplated to emit radiant rays to a coating film on an exterior panel of a workpiece to heat and dry the coating film by means of radiant heat, as disclosed, for example, in JP H11-221513A (corresponds to U.S. Pat. No. 6,062,850). The reason is that, in the drying technique utilizing radiant rays, the radiant rays can be absorbed in the coating film efficiently and evenly, and radiant heat generated by the absorption of the radiant rays allows the coating film to be rapidly heated up from a surface region to an inside region thereof.

However, according to inventor's knowledge obtained through experimental tests, when a coating film is dried by heating based on radiant heat, a surface region of the coating film exhibits a tendency to be heated up to a temperature greater than that of an inside region thereof, and hardened earlier than the inside region, although the coating film can be rapidly heated up on the whole. Thus, if the surface region of the coating film is hardened earlier than the inside region thereof, the hardened surface region precludes release of vapor generated in the inside region due to bumping or the like, to cause a negative effect on a surface quality of the coating film.

### SUMMARY OF THE INVENTION

In view of the above circumstances, it is a first object of the present invention to provide a method capable of drying a coating film on an exterior panel of a box-shaped workpiece within a relatively short period of time, without causing a negative effect on a surface quality of the coating film.

It is a second object of the present invention to provide a coating film drying apparatus suitable for the coating film drying method.

In order to achieve the first object, the present invention provides a method for drying a coating film on an exterior panel of a box-shaped workpiece, which comprises supplying radiant rays, and warm air having a temperature less than a hardening temperature of the coating film, simultaneously and directly to the coating film.

In order to achieve the second object, the present invention provides an apparatus for drying a coating film on an exterior panel of a box-shaped workpiece, which comprises an infrared heater adapted to emit infrared rays to the coating film, and a warm-air blow port adapted to blow warm air having a temperature less than a hardening temperature of the coating film, directly to the coating film, in concurrence with the emission of infrared rays from the infrared heater.

### BRIEF DESCRIPTION OF THE DRAWINGS

FIG. 1 is an explanatory diagram showing a top coating operation using a water-based paint and a top coating operation using a solvent-based paint in a comparative manner.

FIG. 2 is front view showing a drying apparatus according to one embodiment of the present invention.

FIG. 3 is a sectional view taken along the line X3-X3 in FIG. 2.

FIG. 4 is a sectional view taken along the line X4-X4 in FIG. 2.

FIG. 5 is a schematic diagram showing an infrared (IR) heater, wherein a terminal portion thereof is disposed to be exposed to a stream of warm air in a drying passage.

FIG. 6 is an explanatory diagram showing a flow of warm air in a state when a vehicle body is transferred through a drying furnace in FIG. 2.

FIGS. 7A and 7B are tables showing conditions of a coating-film evaluation test and a result of the test, wherein FIG. 7A shows respective test results on Inventive Examples under various conditions, and FIG. 7B respective test results on Comparative Examples under various conditions.

FIG. 8 is a graph showing a relationship between a temperature of a coating film and a preheating time, in each of a drying process using radiant rays and warm air, and a drying process using only warm air.

### DESCRIPTION OF THE PREFERRED EMBODIMENTS

With reference to the drawings, the present invention will now be described based on an embodiment thereof.

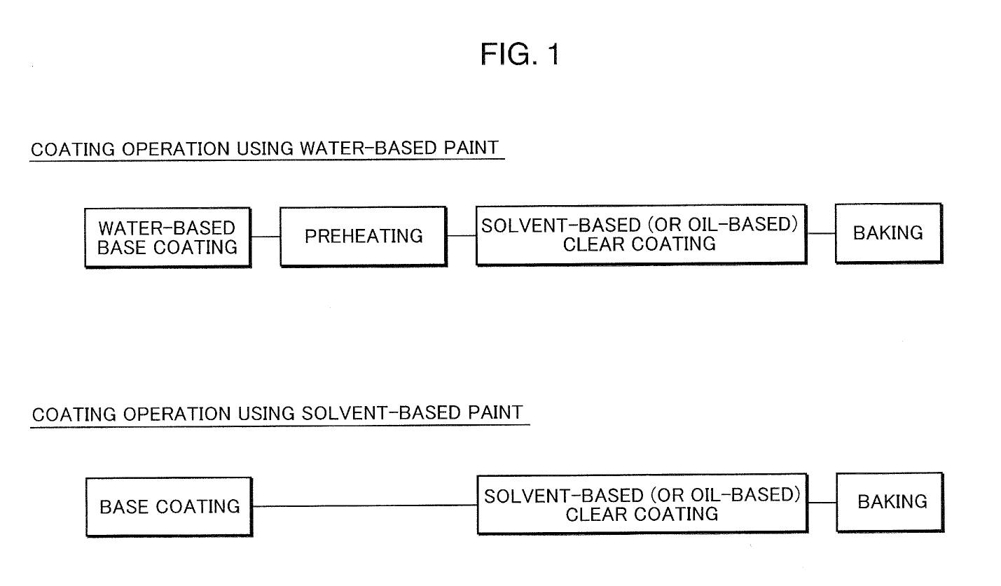

In a coating operation for a vehicle body, the reduction of volatile organic solvents is progressing well. For example, in a top coating operation for a vehicle body, as shown in FIG. 1, when a solvent-based paint is used, a base coating process, a clear coating process and a baking process are performed. In contrast, when a water-based paint is used, it is necessary to interpose a preheating process (including a cooling process) between the base coating process and the clear coating process in order to dry a coating film of the water-based paint before the clear coating process. The preheating process typically requires a process length equivalent to a process time of 4 minutes or more. Thus, in view of space-saving, it is desired to complete the preheating process within a shorter period of time. A coating film drying method according to this embodiment will be described below based on an example where it is used in the preheating process. Before describing details of the coating film drying method according to this embodiment, a drying apparatus 1 applied to use the method will be described.

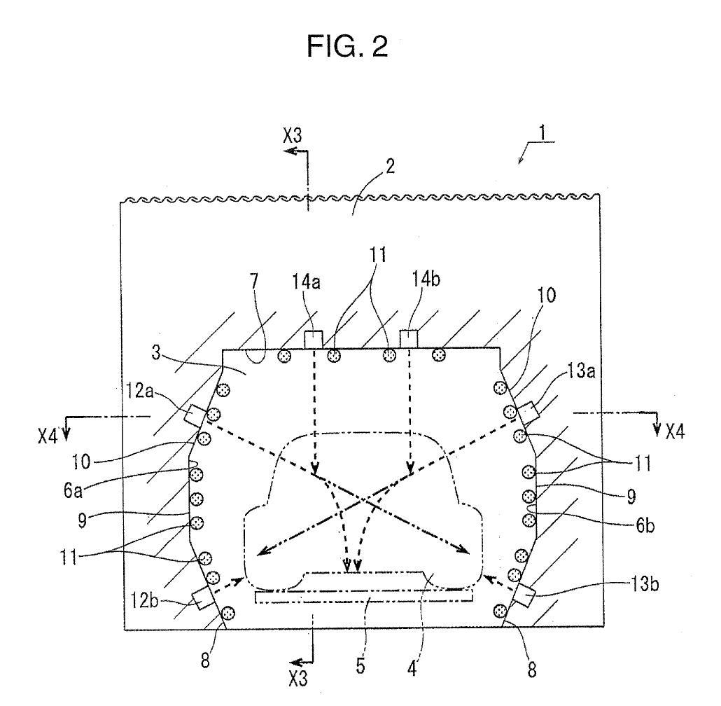

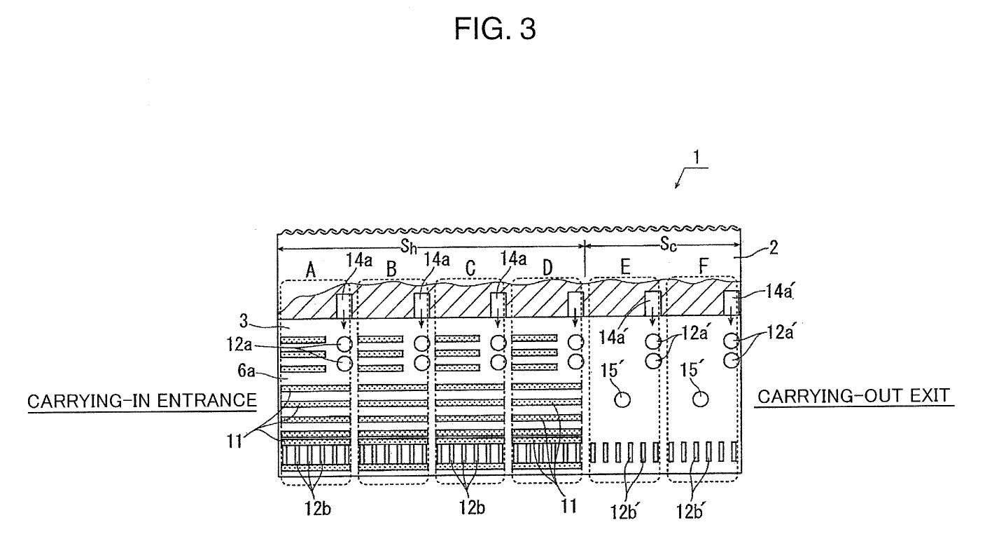

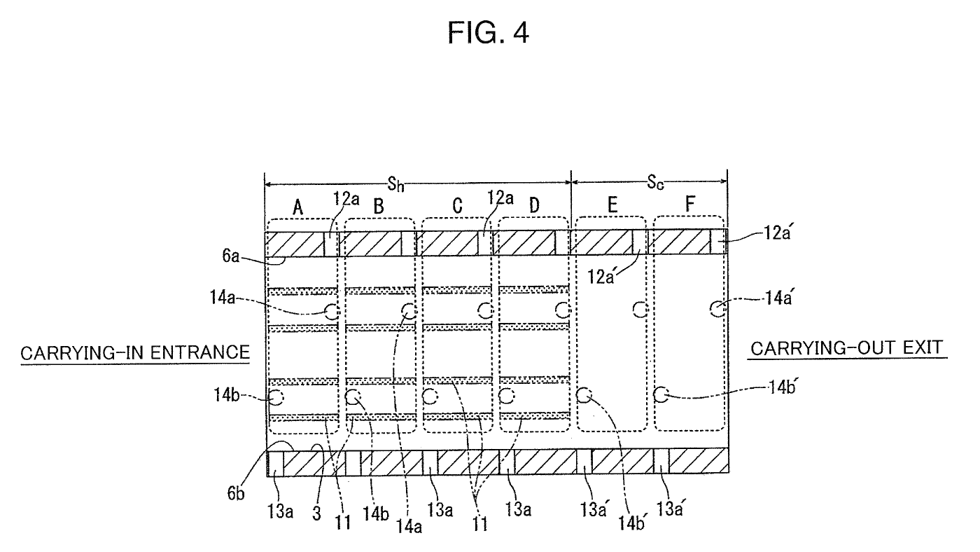

As shown in FIGS. 2 to 4, the drying apparatus 1 comprises a drying furnace 2 extending in one direction. This drying furnace 2 has a passage 3 formed therein to extend in a longitudinal direction thereof. The passage 3 has one end (in FIGS. 3 and 4, left end) opened to the outside to serve as a carrying-in entrance, and the other end (in FIGS. 3 and 4, right end) opened to the outside to serve as a carrying-out exit. A conveyer is disposed in the passage 3 to pass through between the carrying-in entrance and the carrying-out exit, and a transfer table 5 is mounted on the conveyer to transfer a vehicle body 4 as a box-shaped workpiece, while placing the vehicle body 4 thereon. A time required for the transfer table 5 to pass through the drying furnace 2 is set at a predetermined time of 2 minutes or less.

The passage 3 is defined by a pair of opposed lateral wall surfaces 6a, 6b, and a top wall surface 7. Each of the lateral wall surfaces 6a, 6b has a bottom sub-surface 8, a side sub-surface 9 and a shoulder sub-surface 10 each of which extends over the entire length of the drying furnace 2 and which are arranged upwardly from a bottom surface of the passage 3 in this order. The bottom sub-surface 8 is inclined upwardly and outwardly in a widthwise (i.e., lateral) direction of the drying furnace 2 (in FIG. 2, a rightward-leftward direction). Thus, the bottom sub-surface 8 is located on a lateral side of a vehicle body 4 being transferred, in such a manner as to face the vehicle body 4 from an obliquely downward position relative to the vehicle body 4. The side sub-surface 9 extends upright, i.e., vertically. Thus, the side sub-surface 9 located on a lateral side of a vehicle body 4 being transferred, in such a manner as to face a large portion of a lateral surface of the vehicle body 4. The shoulder sub-surface 10 is inclined upwardly and inwardly in the lateral direction of the drying furnace 2. Thus, the shoulder sub-surface 10 is located on a lateral side of a vehicle body 4 being transferred, in such a manner as to face the vehicle body 4 from an obliquely upward position relative to the vehicle body 4. The top wall surface 7 extends horizontally. Thus, the top wall surface 7 is located on an upper side of a vehicle body 4 being transferred, in such a manner as to face the entire top surface of the vehicle body 4 from an upward position relative to the vehicle body 4.

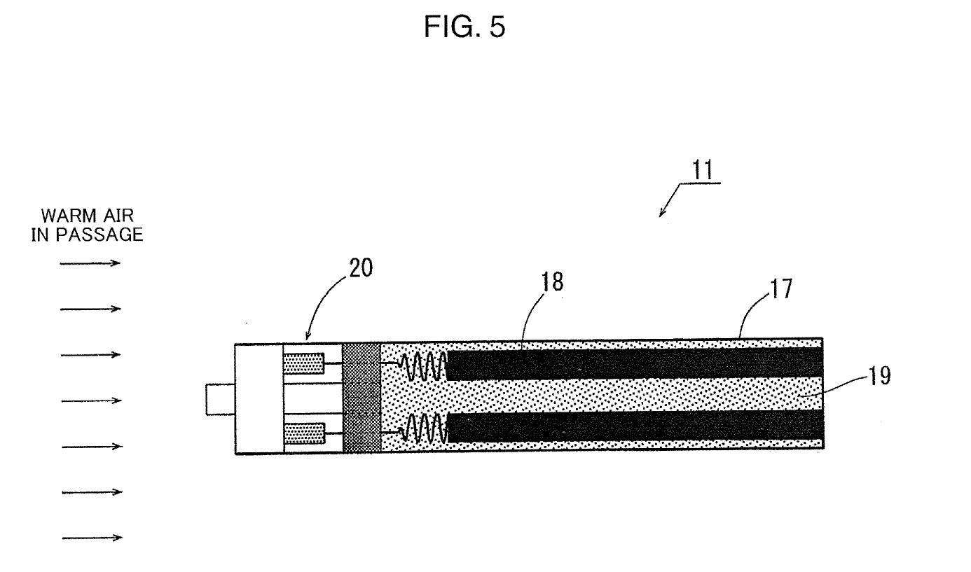

As shown in FIGS. 3 and 4, the entire passage 3 is divided into six areas A to F in the longitudinal direction thereof. The areas A to D make up a heating zone Sh, wherein each of the areas A to D is formed in a common configuration, and the areas E, F make up a cooling zone Sc, wherein each of the areas E, F is formed in a common configuration. In each of the areas A to D, a plurality of IR heaters (infrared electric heaters) 11 are attached to the lateral wall surfaces 6a, 6b and the top wall surface 7. Each of the IR heaters 11 has a function of emitting radiant rays (infrared rays) from a peripheral wall defining the passage 3 toward an inward side of the passage 3. For example, one of various types of heaters adapted to heat a filament to emit radiant rays therefrom (e.g., a medium wave infrared heater (emitter), a carbon heater or a ceramic heater) may be appropriately selected as the IR heater. In this embodiment, as shown in FIG. 5, one type (carbon type) adapted to heat a carbon filament 18 contained in an argon gas-filled silica glass tube 17, to emit radiant rays therefrom is used as the IR heater 11. Generally, in this type of IR heater 11, a metal reflective coat 19 on an inner surface of the silica glass tube 17 is likely to be thermally degraded, and heat crack is likely to occur in a terminal portion 20 (made up of a thin silica glass tube) on the side of a base end. If such crack occurs, air enters into the argon gas-filled silica glass tube 17, to cause burn of the carbon filament 18 and preclude generation of radiant rays. In this embodiment, each of the IR heaters 11 is disposed to be exposed to a stream of warm air in the passage 3, to suppress overheating thereof. This makes it possible to prevent deterioration in durability of each of the IR heaters 11. Each of the IR heaters 11 is adapted to controllably set an output level thereof independently, and a peak wavelength of radiant (infrared) rays is set in the range of 1 to 5 μm, in consideration of selective absorption by water, etc. A lower limit of a total intensity of the IR heaters 11 in each of the areas A to D is set at 10 KW in view of a realistic radiant effect of an IR heater, and an upper limit of the total intensity is set at 75 KW in view of preventing burn of a coating film. One reason why each of the IR heaters 11 is adapted to controllably set an output level thereof independently is to allow respective output levels of the IR heaters 11 to be gradually reduced in a direction from an upstreammost area (area A) to a downstreammost area (area D), as will be described in detail later. Another reason is that, the radiant effect varies depending on a type (shape, size) of vehicle body, a color of a coating film thereof, etc., and thereby it is necessary to allow each of the IR heaters 11 to output a suitable level of radiant energy depending on such factors, so as to minimize energy consumption.

In each of the areas A to D, a plurality of warm-air blow ports 12a, 12b, 13a, 13b, 14a, 14b are opened in the lateral wall surfaces 6a, 6b, and the top wall surface 7 to blow warm air therefrom. In the following description, these warm-air blow ports will be referred to simply as “warm-air blow ports 12 to 14” on a case-by-case basis. After-mentioned cooling-air blow ports (12a′, 12b′, - - - ) will also be expressed in the same manner.

In each of the lateral wall surfaces 6a, 6b, the warm-air blow ports 12a, 12b (13a, 13b) are provided, respectively, in the shoulder sub-surface 10 and the bottom sub-surface 8. The warm-air blow port 12a (13a) in the shoulder sub-surface 10 of the lateral wall surface 6a (6b) is oriented to blow warm air toward the bottom sub-surface 8 of the other lateral wall surface 6b (6a), and the warm-air blow port 12b (13b) in the bottom sub-surface 8 is formed as a plurality of slits, and oriented to blow warm air in an obliquely upward direction. In each of the areas A to D, the warm-air blow port 12a of the lateral wall surface 6a and the warm-air blow port 13a of the lateral wall surface 6b are offset relative to each other in the longitudinal direction of the drying furnace 2. That is, the warm-air blow ports 12a and the warm-air blow ports 13a are arranged alternately (in a zigzag manner) in the direction from the area A to the area D. In each of the areas A to D, the top wall 7 is provided with two warm-air blow ports 14a, 14b. The warm-air blow ports 14a, 14b are disposed in spaced-apart relation to each other in the lateral direction of the drying furnace 2. Further, the warm-air blow ports 14a, 14b are offset relative to each other in the longitudinal direction of the drying furnace 2 in such a manner that the warm-air blow port 14a (14b) and the warm-air blow port 12a (13a) lie on the same vertical plane perpendicular to the longitudinal direction of the drying furnace 2. Thus, as shown in FIG. 2, during absence of a vehicle body 4 as a box-shaped workpiece in one of the areas A to D, a stream of warm air blown from the warm-air blow port 12a (13a) of the lateral wall surface 6a (6b) is directed in a direction causing collision with a heater section of the IR heater 11 on the other lateral wall surface 6b (6a), which leads to deterioration in function of the IR heater 11. However, warm air from the warm-air blow port 14a (14b) of the top wall surface 7 is merged with the warm air from the warm-air blow port 12a (13a) of the lateral wall surface 6a (6b) to change the direction of the warm air from the warm-air blow port 12a (13a) to a direction causing no collision with the IR heater 11. The drying apparatus 1 is adapted to control warm air to be blown from each of the warm-air blow ports 12 to 14, in such a manner that a temperature of the warm air is set in the range of 40 to 100° C., and a flow volume of warm air in each of the areas A to D is set in the range of 50 to m³/m·min while setting a moisture content in the areas A to D at 22 g/kg or less. In this case, “m³/m·min” means an average air volume per 1 meter of the drying furnace.

In each of the areas E, F, the lateral wall surfaces 6a, 6b and the top wall surface 7 are provided with a plurality of cooling-air blow ports 12′ to 14′, 15′ each adapted to blow cooling air therefrom, in place of (i.e., without having) the IR heaters (infrared electric heaters) 11 and the warm-air blow ports. The cooling-air blow ports 12′ to 14′, 15′ in each of the areas E, F are provided in the same arrangement as that of the warm-air blow ports 12 to 14 in each of the areas A to D. The cooling-air blow port 15′ is opened in the side sub-surface 9 in such a manner that the opening of the cooling-air blow port 15′ faces a lateral surface of a vehicle body 4 being transferred. The drying apparatus 1 is adapted to control cooling air to be blown from each of the cooling-air blow ports 12′ to 14′, 15′, in such a manner that a temperature of the cooling air is set in the range of 20 to 45° C., and a flow volume of warm air in each of the areas E, F is set in the range of 50 to 220 m³/m·min.

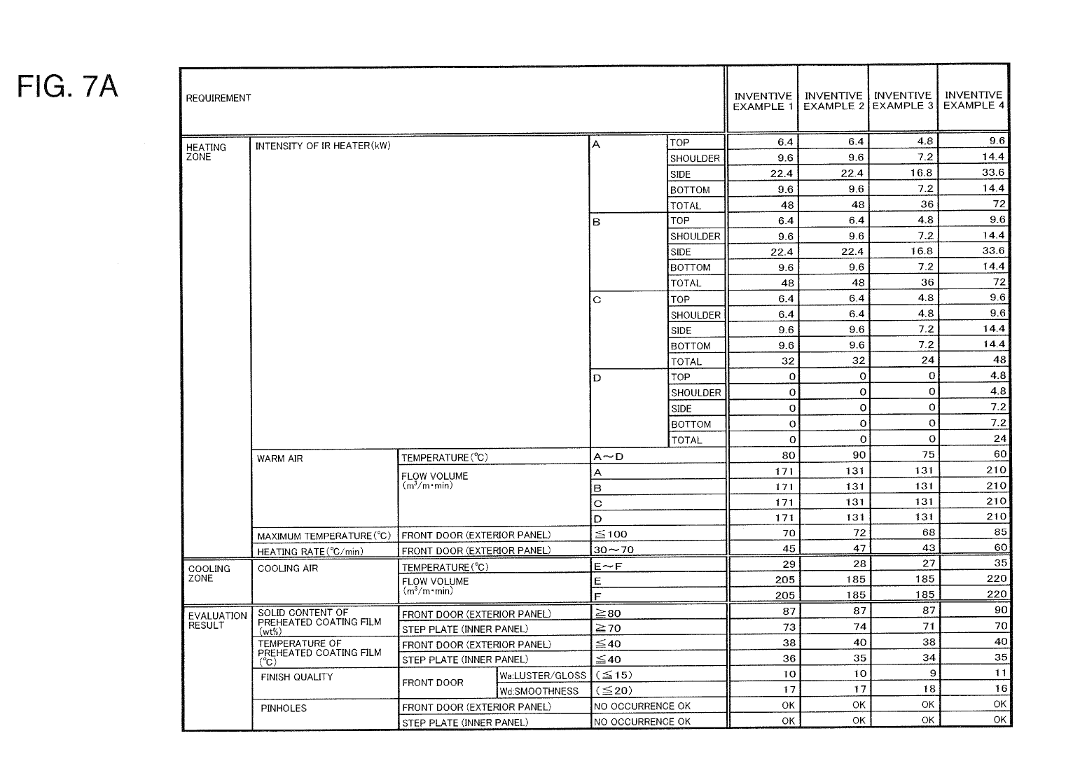

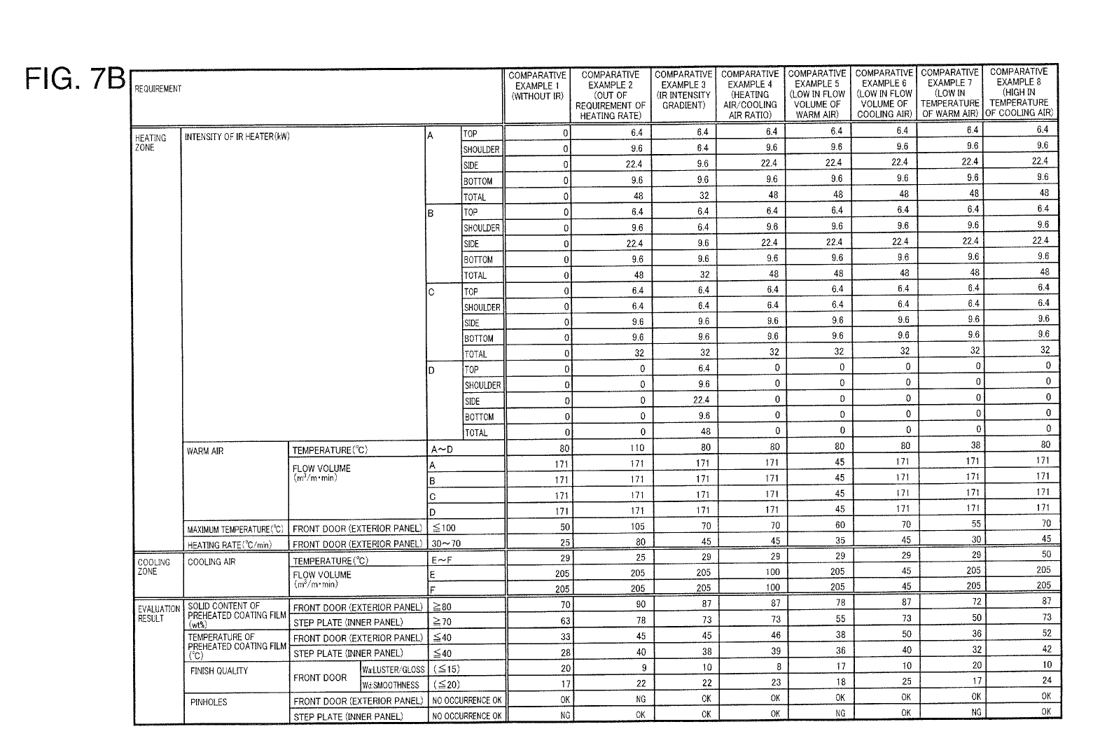

The coating film drying method according to this embodiment will be described below, based on the above drying apparatus 1. A vehicle body 4 (as a box-shaped workpiece) subjected to a base coating process using a water-based paint is carried in the drying apparatus 1. The drying apparatus 1 is activated before the vehicle body 4 is carried in the drying furnace 2. In each of the areas A to D, radiant rays are emitted from each of the IR heaters 11, and warm air is blown from each of the warm-air blow ports 12 to 14. An output level of the IR heaters 11 in each of the areas A to D is set in the range of 10 to 75 KW, in such a manner as to be maximized in the upstreammost area (the area A), and gradually reduced toward the downstream side (toward the area D) (specifically, see each Inventive Example in FIG. 7A). This makes it possible to smoothly perform a cooling operation in the cooling zone Sc (areas E, F) on the downstream side relative to the heating zone Sh, while ensuring a capacity to heating the vehicle body 4. In each of the areas A to D, warm air is blown from the warm-air blow ports 12 to 14 at a temperature ranging from 40 to 100° C. which is less than a hardening temperature of a coating film (in this embodiment, a base coating film), and in a flow volume ranging from 50 to 220 m³/m·min. Specifically, the warm air from the warm-air blow ports 12 to 14 is set to allow a coating film on an exterior panel of the vehicle body 4 to be heated to a maximum temperature of 100° C. or less at a heating rate of 30 to 70° C./min, according to heat based on the warm air, and radiant heat based on the radiant rays. The drying apparatus 1 is not necessarily kept in an operating state before carrying-in of a vehicle body 4. For example, with a view to promoting energy savings, during rest break, or when there is a substantial time before carrying-in of a next vehicle body 4, a switch for the IR heaters etc., may be turned off, and subsequently turned on when the body 4 comes close to the carrying-in entrance of the drying furnace 2.

Concurrently, in each of the areas E, F, cooling air is blown from the cooling-air blow ports 12′ to 15′ at a temperature ranging from 20 to 45° C., and in a flow volume ranging from 50 to 220 m³/m·min. A flow volume of cooling air in each of the areas E, F is set to be equal to or greater than a flow volume of warm air in each of the areas A to D of the heating zone Sh, to adequately cool the coating film of the vehicle body 4.

In this embodiment, in the areas A to D, i.e., the heating zone Sh, warm air is blown from respective warm-air blow ports 14a (14b), 12a (13a), 12b (13b) of the top wall surface 7, the shoulder sub-surface 10 and the bottom sub-surface 8, at a flow-volume ratio of 5 to 30:20 to 60:20 to 60. The reason is as follows. A roof panel of the vehicle body 4 to be located in opposed relation to the top wall surface 7 in the heating zone Sh has a relatively small thickness. Thus, the roof panel can be readily heated up, and therefore a flow volume of warm air may be reduced. In order to allow warm air to reach a door inner panel, it is necessary to blow a relatively large flow volume of warm air from the shoulder sub-surface 10. A side sill of the vehicle body 4 to be located in opposed relation to the bottom sub-surface 8 in the heating zone Sh has a relatively large thickness. Thus, the side sill is hardly heated up, and therefore it is necessary to supply a relatively large flow volume of warm air to the side sill.

In this embodiment, the warm-air blow ports 14a, 14b, the warm-air blow ports 12a, 13a and the warm-air blow ports 12b, 13b are provided, respectively, in the top wall surface 7, the shoulder sub-surface 10 and the bottom sub-surface 8, without providing a warm-air blow port in the side sub-surface 9. It is understood that a warm-air blow port may also be provided in the side sub-surface 9. In this case, considering that a flow volume of warm air from the side sub-surface 9 may be reduced because there are the IR heaters 11 on the sub-surface 9, warm air is preferably blown from respective warm-air blow ports of the top wall surface 7, the shoulder sub-surface 10, the side sub-surface 9 and the bottom sub-surface 8, at a flow-volume ratio of 5 to 30:20 to 60:20 to 60:20 to 60.

In the areas E, F, i.e., the cooling zone Sc, cooling air is preferably blown from respective cooling-air blow ports 14a′ (14b′), 12a′ (13a′), 15′, 12b′ (13b′) of the top wall surface 7, the shoulder sub-surface 10, the side sub-surface 9 and the bottom sub-surface 8, at a flow-volume ratio of 5 to 30:20 to 60:20 to 60:20 to 60. The reason is as follows. The roof panel of the vehicle body 4 to be located in opposed relation to the top wall surface 7 in the cooling zone Sc has a relatively small thickness. Thus, the roof panel can be readily cooled down, and therefore a flow volume of cooling air may be reduced. In order to allow cooling air to reach the door inner panel, it is necessary to blow a relatively large flow volume of cooling air from the shoulder sub-surface 10. The effect of the IR heaters 11 causes difficulty in reducing a temperature of a lateral surface of the vehicle body 4, and therefore it is necessary to ensure an appropriate flow volume of cooling air (about one-half of a flow volume of cooling air in the shoulder sub-surface 10 and the bottom sub-surface 8) in the side sub-surface 9. The side sill of the vehicle body 4 to be located in opposed relation to the bottom sub-surface 8 in the cooling zone Sc has a relatively large thickness. Thus, the side sill is hardly cooled down, and therefore it is necessary to supply a relatively large flow volume of cooling air to the side sill.

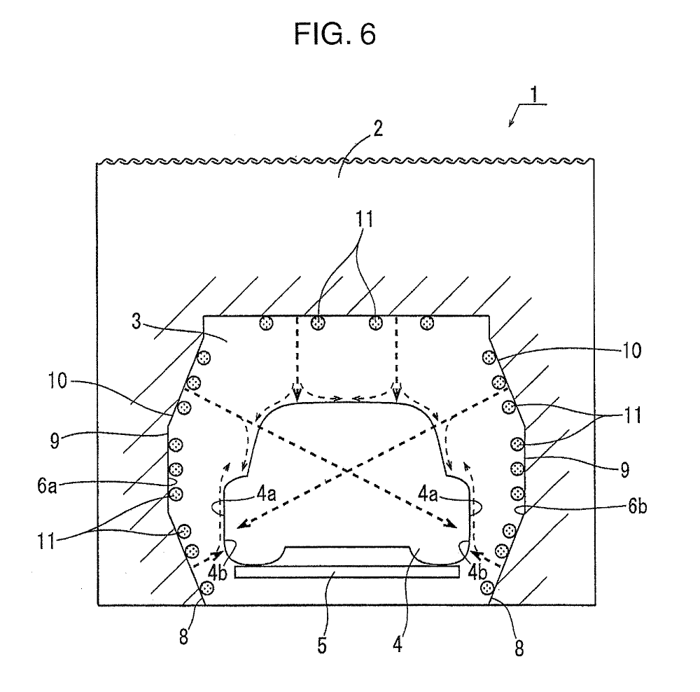

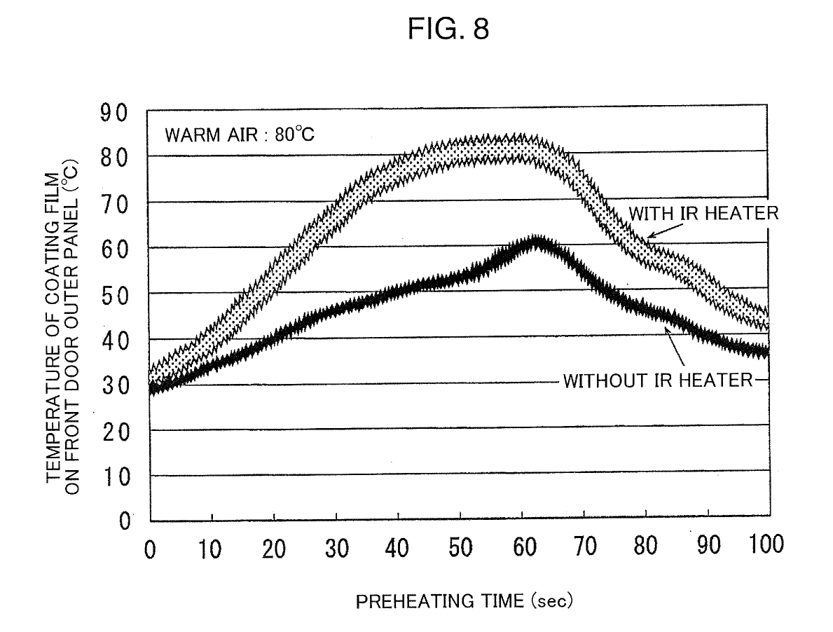

As shown in FIG. 6, when a vehicle body 4 is carried in the drying furnace 2 of the drying apparatus 1, a coating film 4a on an exterior panel of the vehicle body 4 simultaneously receives radiant rays from the IR heaters 11 and warm air (at 100° C. or less; e.g., 80° C.) from the warm-air blow ports 12 to 14 in each of the areas A to D. Thus, as shown in FIG. 8, a temperature of the coating film 4a on the exterior panel (a temperature of a coating film on a front door outer panel) becomes greater than 70° C. within one minute. During this operation, the coating film 4a is heated to a maximum temperature at a heating rate of 30 to 70° C./min, under a condition that the maximum temperature is restricted to 100° C. or less, as described above.

More specifically, in the state illustrated in FIG. 6, the coating film 4a on the exterior panel of the vehicle body 4 receives the radiant rays, and a temperature of the coating film 4a is rapidly increased based on radiant heat, wherein a temperature of a surface region of the coating film 4a is apt to become greater than that of an inside region of the coating film 4a (knowledge found by the inventor). However, the warm air having a temperature less than a hardening temperature of the coating film 4a is simultaneously supplied to a surface of the coating film 4a to exert a relative cooling effect so as to suppress an increase in temperature of the surface region of the coating film 4a to keep the surface region of the coating film 4a from being hardened. This allows vapor generated in the inside region of the coating film 4a due to bumping or the like, to be released through the surface of the coating film 4a so as to prevent deterioration in surface quality (such as pinholes or irregularity) of the coating film 4a.

Further, the warm-air blow ports 12 to 14 are arranged to blow warm air directly against the coating film 4a (see the arrowed wiggle lines in FIG. 6). This makes it possible to effectively increase a film coefficient of heat transfer (film coefficient of convective heat transfer) in the coating film 4a to facilitate improvement in convective heat transfer and effectively exert the relative cooling effect of the warm air on the coating film 4a.

In addition, the warm air (e.g., at 80° C.) is supplied to the coating film 4a instead of cooling air. Thus, under the supply of warm air, significant deterioration of drying capability which would be caused by using cooling air, never occurs. This makes it possible to minimize an increase in drying time which is otherwise caused by degradation of the capability to dry the coating film 4a by heating based on radiant heat, due to cooling of the surface region of the coating film 4a, so that the capability to dry the coating film 4a by heating based on radiant heat can be effectively utilized to allow the coating film 4a to be dried within a shorter period of time.

The warm air blown from the warm-air blow port 12a (13a) in the shoulder sub-surface 10 is supplied to a coating film 4b on an inner panel of the vehicle body 4, through an opening formed in the vehicle body 4, so as to give heat to the coating film 4b to dry the coating film 4b (see the arrowed wiggle lines in FIG. 6). Then, when the warm air is discharged from an opening formed in the vehicle body 4, to the outside, it brings out evaporated water vapor through the opening. At a time when the vehicle body 4 completely passes through the area F, a solid content of the coating film 4a on the exterior panel becomes greater than 80 wt %, and a solid content of the coating film 4b on the inner panel becomes greater than 70 wt %.

When the vehicle body 4 enters into the area E, each of the coating film 4a on the exterior panel of the vehicle body 4 and the coating film 4b on the inner panel of the vehicle body 4 is cooled by cooling air having a temperature less than that of the warm air and a flow volume greater than that in each of the areas A to D. At a time when the vehicle body 4 passes though the area F and carried out of the drying furnace 2, each of the coating films 4a, 4b has a temperature of 40° C. or less. Subsequently, the coating operation will be shifted to the clear coating process.

FIGS. 7A and 7B show test results which support desired conditions. A test for obtaining the test results was carried out by the following testing method.

(1) Measurement of Temperature and Solid Content of Water-Based Coating Film

A thermocouple and a solid content-measuring aluminum foil were installed on each of a front door outer panel (as an exterior panel) and a front door step plate (as an inner panel) of an actual vehicle body 4. Subsequently, a water-based paint (produced by Nippon Paint Co., Ltd.) was sprayed onto the inner panel in such a manner as to allow a dried coating film to have a thickness of 13±3 μm, and the vehicle body 4 was left at room temperature for 120 seconds. Subsequently, an exterior panel of the vehicle body 4 was electrostatically coated with the water-based paint using a rotary-atomizing electrostatic coating machine in such a manner as to allow a dried coating film to have a thickness of 13±3 μm. Given that an operation of electrostatically coating a vertical surface→a horizontal surface of the vehicle body 4 is one cycle, the electrostatic coating operation was repeated twice. After completion of the coating operation, the vehicle body 4 was left at room temperature for 90 seconds, and pre-heated for 2 minutes. A temperature of the vehicle body 4 in a period between start and end of the preheating operation was measured by the thermocouple, and a solid content of the water-based coating film at a time of the end of the preheating operation was derived as follows. A weight A of the aluminum foil was measured in advance of the coating operation. Then, after completion of the preheating operation, the aluminum foil was folded in such a manner that the coating film is not exposed to the outside, and a weight B of the aluminum foil was measured. Subsequently, the aluminum foil was opened in such a manner that the coating film is exposed to the outside, and the coating film was dried at 140° C. for one hour. Then, a weight C of the aluminum foil was measured. Subsequently, a solid content (weight %) of the coating film after the preheating operation was calculated by the following formula: (C−A)/(B−A)×100.

(2) Measurement of External Appearance of Coating Film

An exterior panel of an actual vehicle body 4 was electrostatically coated with a solvent-based intermediate paint H880 (produced by Nippon Paint Co., Ltd.) using a rotary-atomizing electrostatic coating machine in such a manner as to allow a dried coating film to have a thickness of 20±5 μm. Then, after the vehicle body 4 was left at room temperature for 7 minutes, a water-based paint was sprayed onto an inner panel in such a manner as to allow a dried coating film to have a thickness of 13±3 μm, and the vehicle body 4 was left at room temperature for 2 minutes. Subsequently, the exterior panel of the vehicle body 4 was electrostatically coated with the water-based paint using a rotary-atomizing electrostatic coating machine in such a manner as to allow a dried coating film to have a thickness of 13±3 μm. Subsequently, the vehicle body 4 was left at room temperature for 1.5 minutes, and then pre-heated for 2 minutes. After the vehicle body 4 was left at room temperature for 2 minutes, a solvent-based clear paint O-1600 (produced by Nippon Paint Co., Ltd.) was sprayed onto the inner panel in such a manner as to allow a dried coating film to have a thickness of 25±5 μm. After the vehicle body 4 was left at room temperature for 1 minute, the exterior panel was electrostatically coated with the solvent-based clear paint using a rotary-atomizing electrostatic coating machine in such a manner as to allow a dried coating film to have a thickness of 30±5 μm. The vehicle body 4 was left at room temperature for 10 minute, and then dried in an electric furnace at 140° C. for 30 minutes. After completion of the drying operation, finish quality of a coating film was measured Wavescan DOI (produced by BYK-Gardner), and a presence or absence of pinholes was visually determined.

In this test, the following material was used as the water-based paint. 19.0 parts of aluminum paste MH 8801 (aluminum pigment produced by Toyo Aluminium K.K.), 183.3 parts of emulsion resin (volatile matter content: 30%, acid value of solids: 10 mg KOH/g, hydroxyl value: 40), 33.3 parts of water-soluble acrylic resin (acid value of solids: 50 mg KOH/g, solid content: 30%), and 31.25 parts of Cogum® HW-62 (polyacrylamide produced by Showa Highpolymer Co., Ltd., solid content: 15%), were mixed together. Then, 60.0 parts of Neorez® R960 (urethane emulsion produced by Avecia Ltd., active ingredient: 33%) and 5.0 parts of 10% dimethyl ethanolamine aqueous solution were mixed with the mixture and steered together to obtain a water-based paint composition. The obtained water-based paint was diluted and adjusted by ion-exchanged water to have a viscosity of 45 sec at 20° C. as measured by Ford Cup No. 4.

As seen in FIG. 7A, in Inventive Examples meeting requirements, such as a temperature (100° C. or less) of the coating film 4a on the exterior panel (e.g., front door outer panel), and a heating rate (30 to 70° C./min) of the coating film 4a, a desired result could be obtained. Specifically, a solid content of the coating film 4a could be increased up to 80 wt % or more, and a solid content of the coating film 4b could be increased up to 70 wt % or more. In addition, a temperature of the coating film 4a after the preheating operation could be reduced to 40° C. or less. Furthermore, the finish quality, such as luster, gloss and smoothness, met criteria, and no pinhole was observed.

In contrast, as seen in FIG. 7B, in Comparative Examples failing to meet the requirements, had a problem about at least one of the solid content of the coating film after the preheating operation, the temperature of the coating film after the preheating operation, the finish quality and the pinholes occurred.

Although the present invention has been described based on the specific embodiment, it is to be understood that the invention is not limited to the specific embodiment. For example, instead of arranging the cooling-air blow ports 12′ to 14′ in the same manner as that of the warm-air blow ports 12 to 14 as in the above embodiment, the cooling-air blow ports 12′ to 14′ may be arranged in a different manner from that of the warm-air blow ports 12 to 14.

In the tail of the description, features and advantages of the present invention disclosed based on the above embodiment will be summarized as follows.

The present invention provides a method for drying a coating film on an exterior panel of a box-shaped workpiece, which comprises supplying radiant rays, and warm air having a temperature less than a hardening temperature of the coating film, simultaneously and directly to the coating film.

The method of the present invention has an advantage of being able to dry the coating film on the exterior panel of the workpiece within a relatively short period of time without causing a negative effect on a surface quality of the coating film. Specifically, when the coating film on the exterior panel is subjected to drying by heating based on radiant heat, a temperature of a surface region of the coating film is apt to become greater than that of an inside region of the coating film, along with a rapid increase in temperature of the coating film. In the method of the present invention, the warm air having a temperature less than a hardening temperature of the coating film is supplied directly to a surface of the coating film to exert a relative cooling effect so as to effectively suppress an increase in temperature of the surface region of the coating film to keep the surface region of the coating film from being hardened. Thus, vapor generated in the inside region of the coating film due to bumping or the like can be released to keep the surface of the coating film from being adversely affected by the vapor. This makes it possible to prevent the drying operation from causing a negative effect on a surface quality of the coating film of the workpiece. In addition, during the drying operation, the warm air is supplied to the coating film. Thus, significant deterioration of drying capability which would be caused by using cooling air, never occurs. This makes it possible to minimize an increase in drying time which is otherwise caused by degradation of the capability to dry the coating film by heating based on radiant heat, due to cooling of the surface region of the coating film.

The present invention further provides an apparatus for drying a coating film on an exterior panel of a box-shaped workpiece, which comprises an infrared heater adapted to emit infrared rays to the coating film, and a warm-air blow port adapted to blow warm air having a temperature less than a hardening temperature of the coating film, directly to the coating film, in concurrence with the emission of infrared rays from the infrared heater.

The coating film drying apparatus of the present invention can be suitably used in the above coating film drying method.

Preferably, in the method of the present invention, the coating film is heated to a maximum temperature of 100° C. or less at a heating rate of 30 to 70° C./min.

According to this feature, radiant heat based on the radiant rays and heat of the warm air can be adequately utilized to prevent occurrence of burn and pinholes in the coating film.

Preferably, in the method of the present invention, the radiant rays and the warm air are supplied to the coating film on the exterior panel of the workpiece while moving the workpiece along a drying line, and wherein an output level of the radiant rays is maximized at an upstreammost position of the drying line, and gradually reduced toward a downstream side of the drying line.

Preferably, the apparatus of the present invention further comprises a drying furnace adapted to allow the workpiece to pass therethrough, wherein the drying furnace has a heating zone where heating means comprising the infrared heater and the warm-air blow port is disposed on an inner surface of the drying furnace and arranged in a direction from an upstream side to a downstream side of the drying furnace, and wherein an output level of the infrared heater is set in such a manner as to be maximized at an upstreammost position of the drying furnace, and gradually reduced toward the downstream side of the drying furnace.

According to this feature, the radiant rays and the warm air are supplied to the coating film on the exterior panel of the workpiece being transferred along the drying line or drying furnace, and an output level of the radiant rays (an output level of the infrared heater) is set in such a manner as to be maximized at an upstreammost position of the drying line or drying furnace. This makes it possible to emit larger energy of the radiant rays to the coating film when it contains a larger amount of water, to allow the coating film to absorb the radiant rays at a higher rate so as to heat up the coating film effectively and rapidly to accelerate drying. Further, the output level of radiant rays is gradually reduced toward the downstream side of the drying line or drying furnace. Thus, even if radiant rays are used in the drying operation, a cooling load for the dried coating film can be reduced. This makes it possible to reduce a time required for cooling the dried coating film down to an adequate temperature, even if radiant rays are used in the drying operation.

Preferably, in the method of the present invention, the radiant rays and the warm air are supplied to the coating film on the exterior panel of the workpiece, in an upstream area of the drying line, and cooling air having a temperature set to be less than that of the warm air in the upstream area of the drying line is supplied to the coating film on the exterior panel of the workpiece, in a downstream area of the drying line on a downstream side relative to the upstream area, wherein a flow volume of the cooling air in the downstream area of the drying line is set to be equal to or greater than that of the warm air in the upstream area of the drying line.

Preferably, the apparatus of the present invention further comprises: a drying furnace adapted to allow the workpiece to pass therethrough, wherein the drying furnace having a heating zone where heating means comprising the infrared heater and the warm-air blow port is disposed on an inner surface of the drying furnace and arranged in a direction from an upstream side to a downstream side of the drying furnace, and a cooling zone subsequent to the heating zone; and a cooling-air blow port opened in a portion of the inner surface of the drying furnace corresponding to the cooling zone, to blow cooling air, wherein a flow volume of the cooling air from the cooling-air blow port in the cooling zone is set to be greater than that of the warm air from the warm-air blow port in a heating zone.

According to this feature, the radiant rays and the warm air are supplied to the coating film on the exterior panel of the workpiece, in the upstream area of the drying line or drying furnace, and cooling air having a temperature set to be less than that of the warm air is supplied to the coating film, in a downstream area of the drying line or drying furnace. Further, a flow volume of the cooling air is set to be equal to or greater than that of the warm air in the upstream area of the drying line or drying furnace. Thus, a flow of an atmosphere in the heating zone or upstream area toward the cooling zone or downstream area can be suppressed to ensure adequate means for cooling the coating film after the drying operation. This makes it possible to accurately cool the coating film down to an adequate temperature, after drying the coating film.

Preferably, the method of the present invention is used in a process of preheating the coating film on the exterior panel of the workpiece, wherein the coating film is a coating film of a water-based paint.

Preferably, the apparatus of the present invention is used in a process of preheating the coating film on the exterior panel of the workpiece, wherein the coating film is a coating film of a water-based paint.

According to this feature, the method and apparatus can be suitably used in the process of preheating a coating film of a water-based paint.

Preferably, in the method of the present invention, at least a specific one of a plurality of streams of the warm air is directed to a heat source for generating the radiant rays, wherein, during absence of the workpiece, at least one of the remaining streams of the warm air is merged with the specific stream of the warm air to change a direction of the specific stream of the warm air.

Preferably, the apparatus of the present invention includes a plurality of the infrared heaters and a plurality of the warm-air blow ports, wherein at least a specific one of the plurality of warm-air blow ports is disposed in opposed relation to a part of the plurality of infrared heaters, and at least one of the remaining warm-air blow ports is disposed to blow the warm air in a direction crossing a direction toward which the specific warm-air blow port is oriented.

According to this feature, during absence of the workpiece, a direction of at least a specific one of a plurality of streams of the warm air directed to a heat source for generating the radiant rays (e.g., infrared heater) is changed by merging at least one of the remaining streams of the warm air therewith. This makes it possible to prevent the heat source from being positively cooled by the warm air, so as to avoid deterioration in efficiency of radiant ray-based drying, in a simple manner.

Preferably, in the method of the present invention, the workpiece has an opening which provides fluid communication between an outside and an inside thereof, and includes an inner panel having thereon a coating film to be dried, wherein the warm air is supplied to the coating film on the inner panel of the workpiece, from the outside of the workpiece through the opening.

Preferably, in the apparatus of the present invention, the workpiece has an opening which provides fluid communication between an outside and an inside thereof, and includes an inner panel having thereon a coating film to be dried, wherein the warm-air blowing port includes at least one warm-air blowing port adapted to supply the warm air to the coating film on the inner panel of the workpiece from the outside of the workpiece through the opening.

According to this feature, the warm air is supplied to the coating film on the inner panel of the workpiece, from the outside of the workpiece through the opening. This makes it possible to dry the coating film on the inner panel of the workpiece, by heat of the warm air, while allowing the warm air to flow between the outside and the inside of the workpiece through the opening so as to efficiently discharge moisture to the outside.

This application is based on Japanese Patent application No. 2007-296597 filed in Japan Patent Office on Nov. 15, 2007, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A method for drying a coating film on an exterior panel of a box-shaped workpiece, comprising supplying radiant rays, and warm air having a temperature less than a hardening temperature of said coating film, simultaneously and directly to said coating film.

2. The method as defined in claim 1, wherein said coating film is heated to a maximum temperature of 100° C. or less at a heating rate of 30 to 70° C./min.

3. The method as defined in claim 1, wherein said radiant rays and said warm air are supplied to said coating film on said exterior panel of said workpiece while moving said workpiece along a drying line, and wherein an output level of said radiant rays is maximized at an upstreammost position of said drying line, and gradually reduced toward a downstream side of said drying line.

4. The method as defined in claim 3, wherein:
said radiant rays and said warm air are supplied to said coating film on said exterior panel of said workpiece, in an upstream area of said drying line; and
cooling air having a temperature set to be less than that of said warm air in said upstream area of said drying line is supplied to said coating film on said exterior panel of said workpiece, in a downstream area of said drying line on a downstream side relative to said upstream area, wherein a flow volume of said cooling air in said downstream area of said drying line is set to be equal to or greater than that of said warm air in said upstream area of said drying line.

5. The method as defined in claim 1, which is used in a process of preheating said coating film on said exterior panel of said workpiece, wherein said coating film is a coating film of a water-based paint.

6. The method as defined in claim 1, wherein at least a specific one of a plurality of streams of said warm air is directed to a heat source for generating said radiant rays, wherein, during absence of said workpiece, at least one of the remaining streams of said warm air is merged with said specific stream of said warm air to change a direction of said specific stream of said warm air.

7. The method as defined in claim 1, wherein said workpiece has an opening which provides fluid communication between an outside and an inside thereof, and includes an inner panel having thereon a coating film to be dried, wherein said warm air is supplied to said coating film on said inner panel of said workpiece from the outside of said workpiece through said opening.

8. An apparatus for drying a coating film on an exterior panel of a box-shaped workpiece, comprising:
an infrared heater adapted to emit infrared rays to said coating film; and
a warm-air blow port adapted to blow warm air having a temperature less than a hardening temperature of said coating film, directly to said coating film, in concurrence with the emission of infrared rays from said infrared heater.

9. The apparatus as defined in claim 8, further comprising a drying furnace adapted to allow said workpiece to pass therethrough, said drying furnace having a heating zone where heating means comprising said infrared heater and said warm-air blow port is disposed on an inner surface of said drying furnace and arranged in a direction from an upstream side to a downstream side of said drying furnace, wherein an output level of said infrared heater is set in such a manner as to be maximized at an upstreammost position of said drying furnace, and gradually reduced toward the downstream side of said drying furnace.

10. The apparatus as defined in claim 8, further comprising:
a drying furnace adapted to allow said workpiece to pass therethrough, said drying furnace having a heating zone where heating means comprising said infrared heater and said warm-air blow port is disposed on an inner surface of said drying furnace and arranged in a direction from an upstream side to a downstream side of said drying furnace, and a cooling zone subsequent to said heating zone; and
a cooling-air blow port opened in a portion of the inner surface of said drying furnace corresponding to said cooling zone, to blow cooling air, wherein a flow volume of said cooling air from said cooling-air blow port in said cooling zone is set to be greater than that of said warm air from said warm-air blow port in a heating zone.

11. The apparatus as defined in claim 8, which is used in a process of preheating said coating film on said exterior panel of said workpiece, wherein said coating film is a coating film of a water-based paint.

12. The apparatus as defined in claim 8, which includes a plurality of the infrared heaters and a plurality of the warm-air blow ports, wherein at least a specific one of said plurality of warm-air blow ports is disposed in opposed relation to a part of said plurality of infrared heaters, and at least one of the remaining warm-air blow ports is disposed to blow said warm air in a direction crossing a direction toward which said specific warm-air blow port is oriented.

13. The apparatus as defined in claim 8, wherein said workpiece has an opening which provides fluid communication between an outside and an inside thereof, and includes an inner panel having thereon a coating film to be dried, wherein said warm-air blowing port includes at least one warm-air blowing port adapted to supply said warm air to said coating film on said inner panel of said workpiece from the outside of said workpiece through said opening.
